(19) United States
(12) Patent Application Publication
(10) Pub. No.: US 2025/0015407 A1
(43) Pub. Date: Jan. 9, 2025

(54) LAMINATED BATTERY

(71) Applicant: TOYOTA JIDOSHA KABUSHIKI KAISHA, Toyota-shi (JP)

(72) Inventors: Kenichi KAKISHITA, Nagoya-shi (JP); Sumiko KITO, Nagoya-shi (JP)

(73) Assignee: TOYOTA JIDOSHA KABUSHIKI KAISHA, Toyota-shi (JP)

(21) Appl. No.: 18/741,772

(22) Filed: Jun. 13, 2024

(30) Foreign Application Priority Data
Jul. 6, 2023 (JP) 2023-111751

(51) Int. Cl. H01M 50/184; H01M 50/105; H01M 50/186

(52) U.S. Cl. CPC H01M 50/184; H01M 50/105; H01M 50/186

(57) ABSTRACT

The laminated battery of the present disclosure includes an electrode body and a laminate film that covers and encloses the electrode body. The laminate film has a fused portion in which end portions are superposed to each other and an inner surface is fused. The fused portion is bent along a folding line extending in a longitudinal direction of the fused portion. The fused portion has a surface facing the electrode body in a region closer to the distal end than the folding line, and has a wavy shape along the longitudinal direction of the fused portion.

### CROSS-REFERENCE TO RELATED APPLICATION

This application claims priority to Japanese Patent Application No. 2023-111751 filed on Jul. 6, 2023, incorporated herein by reference in its entirety.

### BACKGROUND

### 1. Technical Field

The present disclosure relates to a laminated battery.

### 2. Description of Related Art

In a laminated battery in which an electrode body is covered by laminate films, part of the laminate films is fused to form a fused portion in order to seal the electrode body.

Japanese Unexamined Patent Application Publication No. 2019-200973 (JP 2019-200973 A) discloses a method of manufacturing a secondary battery in which a folded portion is provided at least at one end of a laminated exterior body of the secondary battery. The manufacturing method disclosed in JP 2019-200973 A includes a first step and a second step. The first step and the second step are performed in this order. In the first step, a holding plate is brought into contact with a folding base point at the end of the exterior body. In the second step, the holding plate and a pressing plate positioned to face the holding plate are slid to sandwich the end. Then, the end is folded about the base point and clamped by the holding plate and the pressing plate to form the folded portion. Surfaces of the pressing plate that slide against the end include an inclined surface that folds the end and a clamping surface that clamps the end. The inclined surface is inclined such that the sectional area of the pressing plate decreases in a sliding direction in a cross section orthogonal to a width direction of the pressing plate. The inclined surface is inclined in the width direction.

### SUMMARY

In a laminated battery in which an electrode body is covered by a single laminate film, one end side and the other end side of the laminate film are superposed on each other, and the inner surfaces are fused to form a fused portion. Thus, the electrode body is sealed with the laminate film. In a laminated battery in which an electrode body is covered by a plurality of laminate films, the ends of the laminate films are superposed on each other, and the inner surfaces are fused to form a fused portion. Thus, sealing is achieved. In order to improve the structural efficiency of the laminated battery, the fused portion is, for example, folded to reduce the size of the outer shape of the entire laminated battery.

When the electrode body in the laminated battery receives an impact, there is a possibility that the electrode body is damaged and the required performance of the battery cannot be exhibited. Therefore, the laminated battery is required to have impact resistance.

A part of the fused portion of the laminated battery disclosed in JP 2019-200973 A on the distal end side from the folding base point (hereinafter also referred to as “folded part”) is planar. Therefore, when the laminated battery receives an external impact (for example, a lateral strike), there is a possibility that the folded part does not function as a cushion against the impact. As a result, the impact resistance of the laminated battery disclosed in JP 2019-200973 A may be insufficient.

The present disclosure has been made in view of the above circumstances. An object of an embodiment of the present disclosure is to provide a laminated battery having excellent impact resistance against an external impact.

The means for addressing the above object includes the following aspects.

A laminated battery according to an aspect of the present disclosure includes:
an electrode body; and
a laminate film that covers and seals the electrode body inside, in which
the laminate film includes a fused portion in which ends are superposed on each other and inner surfaces are fused,
the fused portion is folded along a folding line extending in a longitudinal direction of the fused portion, and
the fused portion includes a surface that faces the electrode body in a region on a distal end side from the folding line, and has an undulating shape along the longitudinal direction of the fused portion.

In the above aspect, the fused portion includes the surface that faces the electrode body in the region on the distal end side from the folding line (hereinafter also referred to as “folded region”), and has the undulating shape (hereinafter also referred to as “wavy shape”) along the longitudinal direction of the fused portion. The folded region generally has a moderate shape retaining property. Therefore, when the folded region receives an external impact (for example, a lateral strike), the folded region is more likely to function as a cushion against the impact than in a case where the folded region is planar. As a result, the laminated battery of the above aspect has excellent impact resistance against the external impact.

In the laminated battery of the above aspect,
the number of peaks of a wave of the shape may be two or more, and a height difference between the peak of the wave of the shape and a valley of the wave at a distal end of the fused portion may be equal to or larger than 0.5 mm.

In the present disclosure, the “height difference between the peak of the wave and the valley of the wave” indicates a distance between the top of the peak and the bottom of the valley adjacent to the peak.

In the above aspect, when the folded region receives an external impact (for example, a lateral strike), the folded region is even more likely to function as the cushion against the impact than in a case where the folded region does not satisfy the above condition. As a result, the laminated battery of the above aspect has more excellent impact resistance against the external impact.

In the laminated battery of the above aspect,
the fused portion may be folded into an angular shape or an arc shape along the folding line.

In the above aspect, the folded region has a more excellent shape retaining property than in a case where the fused portion is not folded into the angular shape or the arc shape along the folding line. As a result, the laminated battery of the above aspect has more excellent impact resistance against the external impact.

In the laminated battery of the above aspect,
in the longitudinal direction of the fused portion, a length at a distal end of the shape may be larger than a length of the fused portion at the folding line.

In the above aspect, when the folded region receives an external impact (for example, a lateral strike), the folded region is even more likely to function as the cushion against the impact than in a case where the folded region does not satisfy the above condition. As a result, the laminated battery of the above aspect has more excellent impact resistance against the external impact.

According to the present disclosure, the laminated battery having excellent impact resistance against the external impact is provided.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an external perspective view of a laminated battery according to an embodiment of the present disclosure;

FIG. 2 is a cross-sectional view of II-II of FIG. 1;

FIG. 3 is a top view of a laminated battery according to an embodiment of the present disclosure; and

FIG. 4 is an external perspective view of a semi-finished product of a laminated battery according to an embodiment of the present disclosure.

### DETAILED DESCRIPTION OF EMBODIMENTS

In the present disclosure, a numerical range indicated by using “from” means a range including the numerical values described before and after “from” as the minimum value and the maximum value, respectively. In the numerical range described in the present disclosure in a stepwise manner, the upper limit value or the lower limit value described in a certain numerical range may be replaced with the upper limit value or the lower limit value of the numerical range described in another stepwise manner. In the present disclosure, a combination of two or more preferred embodiments is a more preferred embodiment. In the present disclosure, the term “step” is included in the term as long as the intended purpose of the step is achieved, even if it is not clearly distinguishable from other steps as well as independent steps.

Hereinafter, embodiments of a laminated battery, a battery stack, and a method of manufacturing a laminated battery of the present disclosure will be described with reference to the drawings. In the drawings, the same or corresponding parts are denoted by the same reference numerals, and description thereof will not be repeated.

### Laminated Battery

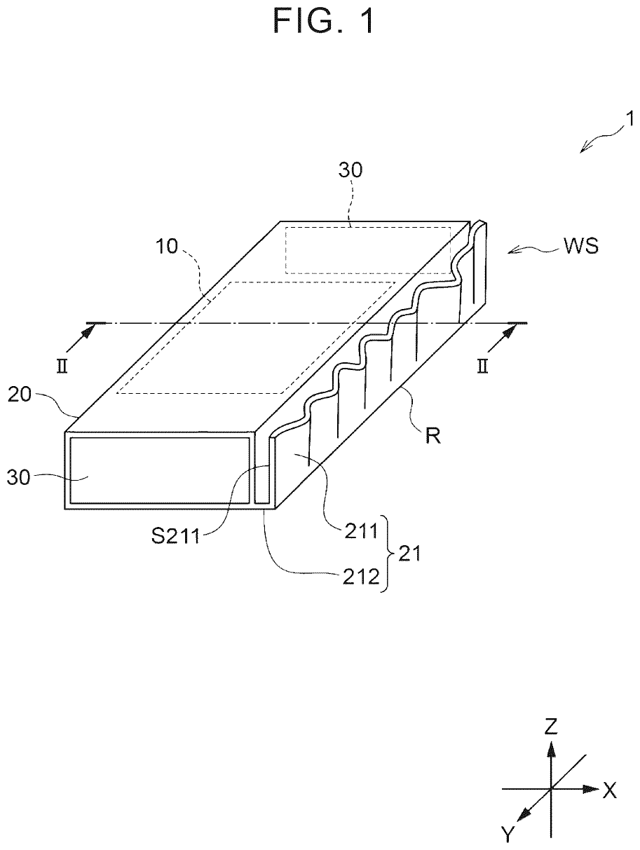

As illustrated in FIG. 1, a laminated battery 1 according to an embodiment of the present disclosure includes an electrode body 10, a laminate film 20, and a pair of terminals 30. One of the pair of terminals 30 is a positive electrode terminal. The other of the pair of terminals 30 is a negative electrode terminal. The laminated battery 1 is a rectangular parallelepiped.

In the present embodiment, one side of the main surface of the laminated battery 1 in the lateral direction is defined as the X-axis positive direction, and the opposite side thereof is defined as the X-axis negative direction. One side of the main surface of the laminated battery 1 in the longitudinal direction is defined as a Y-axis positive direction, and the opposite side thereof is defined as a Y-axis negative direction. One side of the laminated battery 1 in the thickness direction is defined as the positive Z-axis direction, and the opposite side thereof is defined as the negative Z-axis direction. Each of the X-axis, the Y-axis, and the Z-axis is orthogonal to each other. Note that these orientations do not limit the orientation of the laminated battery 1 of the present disclosure when used.

The pair of terminals 30 are disposed to face each other with the electrode body 10 interposed therebetween. The electrode body 10 is electrically connected to each of the pair of terminals 30. The laminate film 20 covers and encloses the electrode body 10. The laminate film 20 covers a part of the pair of terminals 30.

### Laminate Film

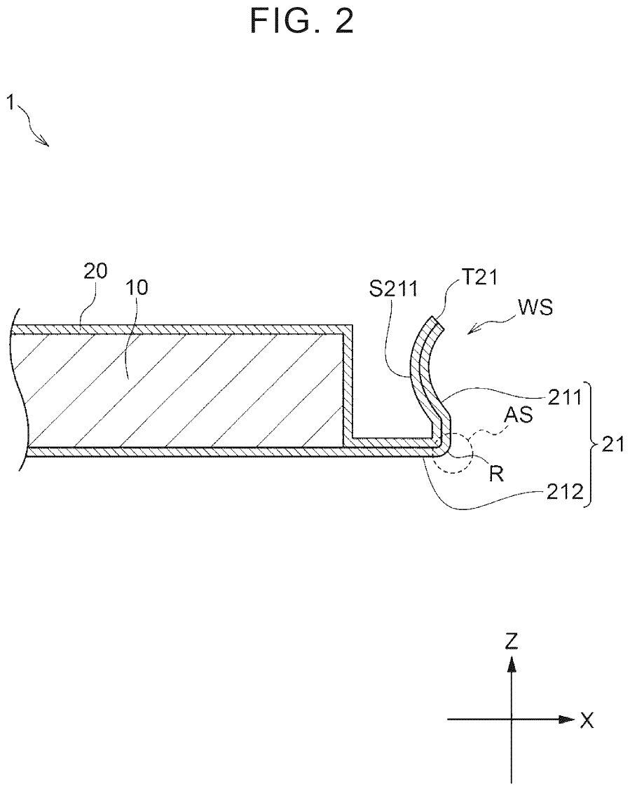

The laminate film 20 is a single sheet. The laminate film 20 has a fused portion 21 in which end portions are superposed to each other and an inner surface is fused. The fused portion 21 is bent along the folding line R. The folding line R extends along the longitudinal direction (i.e., the Y-axis direction) of the fused portion 21. In the present embodiment, as shown in FIG. 2, the fused portion 21 is bent in an arcuate AS along the folding line R.

The fused portion 21 has a folded region 211 and a non-folded region 212. The folded region 211 is bent with respect to the main surface (XY plane) of the laminated battery 1. The folded region 211 indicates a region closer to the distal end side of the fused portion 21 than the folding line R of the fused portion 21. The non-folded regions 212 are not folded with respect to the main surface (XY plane) of the laminated battery 1. The non-folded region 212 indicates a region of the fused portion 21 on the side opposite to the distal end side of the fused portion 21 with respect to the folding line R.

### Wave Shape

The folded region 211 has a surface S211 facing the electrode body 10. The folded region 211 has a corrugated shaped WS (hereinafter, also referred to as “corrugated WS”) along the longitudinal direction (Y-axis direction) of the fused portion 21.

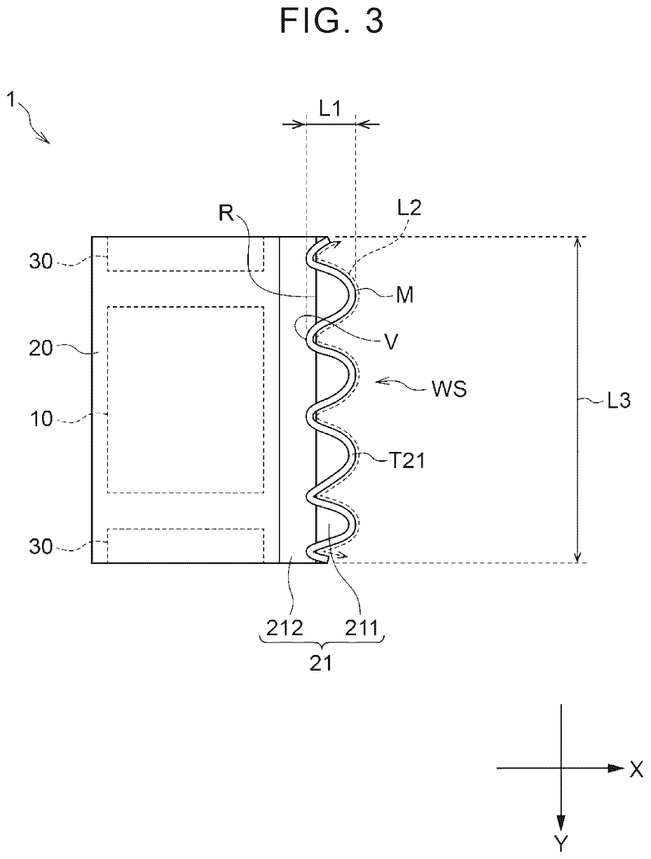

In the present embodiment, as shown in FIG. 3, there are two or more peaks M of waves in the corrugated WS. At the distal end of the fused portion 21, the height difference L1 (see FIG. 3) between the corrugated peak M of the corrugated WS and the valley V of the wave is 0.5 mm or more.

In the present embodiment, in the longitudinal direction (Y-axis direction) of the fused portion 21, the length L2 of the corrugated WS at the distal end T21 (see FIG. 2) is longer than the length L3 of the folding line R of the fused portion 21.

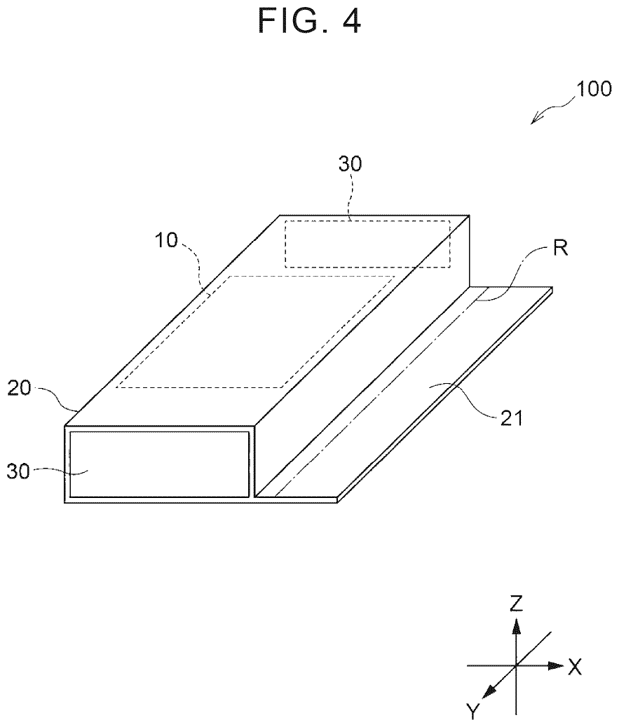

FIG. 4 shows an external perspective view of a semi-finished product 100 of the laminated battery 1. The configuration of the semi-finished product 100 is the same as that of the laminated battery 1 except that the fused portion 21 is not subjected to the bending process. The corrugated WS is formed by subjecting the semi-finished product 100 to a bending process by a known roll forming method. Specifically, when the fused portion 21 of the semi-finished product 100 is passed between each of a plurality of pair of rollers and the fused portion 21 is bent stepwise, the distal end T21 of the fused portion 21 is plastically deformed by being pulled toward the other side of the folding line R in the lateral direction of the fused portion 21. As a result, a corrugated WS is formed in the folded region 211. The length L2 of the corrugated WS is mainly adjusted by the bending angle caused by the passage of the pair of rollers and the roll pitch of the pair of adjacent rollers. The “bending angle” indicates the angle of the folded region 211 with respect to the main surface (XY plane) of the laminated battery 1.

### Film Composition

The laminate film 20 may be any known laminate film used in a laminated battery, and may be a film having a three-layer structure. The three-layer film includes a metal layer, a first resin layer disposed on one main surface of the metal layer, and a second resin layer disposed on the other main surface of the metal layer. The first resin layer may function as a fusion layer, and the second resin layer may function as a protective layer.

Examples of the fusion layer include olefin-based resins such as polypropylene (PP) and polyethylene (PE). Examples of the material of the metal layer include aluminum, aluminum alloy, and stainless steel. Examples of the protective layer include polyethylene terephthalate (PET) and nylon. The thickness of the fusion layer may be from 40 μm to 100 μm. The thickness of the metal layer may be from 30 μm to 60 μm or less. The thickness of the protective layer may be 20 μm to 60 μm. The thickness of the laminate film 20 may be from 70 μm to 220 μm.

### Electrode Body

The electrode body 10 functions as a power generation element of the laminated battery 1. The shape of the electrode body 10 is not particularly limited, and examples thereof include a shape of a rectangular parallelepiped and a shape in which an end surface is an inclined surface. The electrode body is formed by stacking a plurality of unit electrode layers along the Z-axis direction. The unit electrode layer includes a positive electrode current collector, a positive electrode mixture layer, a solid electrolyte layer, a negative electrode mixture layer, and a negative electrode current collector stacked in this order along the Z-axis direction.

Examples of the material of the positive electrode current collector include aluminum, copper, stainless steel, nickel, iron, titanium, and carbon. Each of the positive electrode current collectors has, for example, a foil shape or a mesh shape.

The positive electrode mixture layer contains a positive electrode active material (e.g., LiCoO₂, LiMn₂O₄, or LiFePO₄). The positive electrode mixture layer may further contain a solid electrolyte (for example, a sulfide solid electrolyte, an oxide solid electrolyte, or a halogenated solid electrolyte), a conductive material (for example, acetylene black, metal particles, or a conductive polymer), and a binder (for example, styrene-butadiene rubber or polyvinylidene fluoride) as necessary.

The solid electrolyte layer contains a solid electrolyte (for example, a sulfide solid electrolyte, an oxide solid electrolyte, or a halogenated solid electrolyte), and may further contain a binder (for example, styrene-butadiene rubber or polyvinylidene fluoride) as necessary. The composition of the sulfide solid electrolyte is, for example, xLi₂S·(100−x)P₂S₅ (70≤x≤80), yLiI·zLiBr·(100−y−z) (xLi₂S·(1−x) P₂S₅) (0.7≤x≤0.8, 0≤y≤30, 0≤z≤30). Examples of the oxide solid electrolyte include a garnet-type solid electrolyte, a perovskite-type solid electrolyte, a Nasicon-type solid electrolyte, a Li—P—O type solid electrolyte, and a Li—B—O type solid electrolyte. The halogenated solid electrolyte is, for example, a Li_{6-3z}Z_{z}X₆ (where X is at least one of Cl and Br, and z is 0<z<2).

Examples of the material of the negative electrode current collector include aluminum, copper, stainless steel, nickel, iron, titanium, and carbon. The shape of the negative electrode current collector is, for example, a foil shape or a mesh shape.

The negative electrode mixture layer contains a negative electrode active material (for example, metallic lithium, graphite, lithium titanate, or Si alone). The negative electrode mixture layer may further contain a solid electrolyte (for example, a sulfide solid electrolyte, an oxide solid electrolyte, or a halogenated solid electrolyte), a conductive material (for example, acetylene black, metal particles, or a conductive polymer), and a binder (for example, styrene-butadiene rubber or polyvinylidene fluoride) as necessary.

### Terminal

The terminal 30 is a rectangular parallelepiped object having a longitudinal direction in the X-axis direction and a lateral direction in the Z-axis direction. Examples of the material of the terminal 30 include metallic materials (for example, Steel Use Stainless (SUS) and the like).

### Use

Examples of the use of the laminated battery 1 include a power supply of a vehicle, a power supply of a moving body (for example, a railway, a ship, or an aircraft) other than the vehicle, and a power supply of an electric product (an information processing apparatus or the like). Examples of vehicles include hybrid electric vehicle (HEV), plug-in hybrid electric vehicle (PHEV), battery electric vehicle (BEV), gasoline-powered vehicles, diesel-powered vehicles, and the like.

### Effect

As described with reference to FIGS. 1 to 4, the laminated battery 1 includes an electrode body 10 and a laminate film 20. The laminate film 20 has a fused portion 21. The fused portion 21 is bent along the folding line R. The fused portion 21 has a surface S211 facing the electrode body 10 in the folded region 211 and has a corrugated WS. The folded region 211 typically has a moderate shape retention. Therefore, when an impact (for example, a side collision or the like) is applied to the folded region 211 from the outside, the folded region 211 is more likely to function as a shock absorbing material than when the folded region 211 has a planar shape. As a result, the laminated battery 1 has excellent impact resistance against external impact.

As described with reference to FIGS. 1 to 4, the laminated battery 1 has two or more corrugated peaks M of corrugated WS and a height difference L1 (see FIG. 3) at the distal end T21 of the fused portion 21 is 0.5 mm or more.

As a result, when an impact (for example, a side collision or the like) is applied to the folded region 211 from the outside, the folded region 211 is more likely to function as an impact cushioning material than when the folded region 211 does not satisfy the above condition. As a result, the laminated battery 1 is more excellent in impact resistance against external impact.

As described with reference to FIGS. 1 to 4, in the laminated battery 1, the fused portion 21 is bent in an arc shape along the folding line R.

As a result, the folded region 211 has a shape retention property that is superior to the case where the fused portion 21 is not bent in a corner shape or an arc shape along the folding line R. As a result, the laminated battery 1 is more excellent in impact resistance against external impact.

As described with reference to FIGS. 1 to 4, in the laminated battery 1, the length L2 (see FIG. 3) of the corrugated WS in the distal end T21 in the longitudinal direction (Y-axis direction) of the fused portion 21 is longer than the length L3 of the folding line R of the fused portion 21.

As a result, when an impact (for example, a side collision or the like) is applied to the folded region 211 from the outside, the folded region 211 is more likely to function as an impact cushioning material than when the folded region 211 does not satisfy the above condition. As a result, the laminated battery 1 is more excellent in impact resistance against external impact.

### Modification

In the laminated battery 1, the corrugated WS has two or more corrugated peaks M, and the height difference L1 (see FIG. 3) is 0.5 mm or more, but the present disclosure is not limited thereto. The laminated battery of the present disclosure is not required to satisfy at least one of the followings: the number of corrugated peaks M of the corrugated WS is two or more, and the height difference L1 (see FIG. 3) at the distal end T21 of the fused portion 21 is 0.5 mm or more.

In the laminated battery 1, the fused portion 21 is bent in an arc shape along the folding line R, but the present disclosure is not limited thereto. The fused portion 21 may be bent in a corner shape along the folding line R, or may be bent in a shape different from either of an arc shape and a corner shape. “Angular” refers to a shape having corners.

The electrode body 10 is an all-solid-state battery including a solid electrolyte layer, but may be a lithium secondary battery including a nonaqueous electrolyte, or a metal-ion secondary battery (for example, a sodium-ion secondary battery, a magnesium-ion secondary battery, or the like).

What is claimed is:

1. A laminated battery comprising:
an electrode body; and
a laminate film that covers and seals the electrode body inside, wherein:
the laminate film includes a fused portion in which ends are superposed on each other and inner surfaces are fused;
the fused portion is folded along a folding line extending in a longitudinal direction of the fused portion; and
the fused portion includes a surface that faces the electrode body in a region on a distal end side from the folding line, and has an undulating shape along the longitudinal direction of the fused portion.

2. The laminated battery according to claim 1, wherein the number of peaks of a wave of the shape is two or more, and a height difference between the peak of the wave of the shape and a valley of the wave at a distal end of the fused portion is equal to or larger than 0.5 mm.

3. The laminated battery according to claim 1, wherein the fused portion is folded into an angular shape or an arc shape along the folding line.

4. The laminated battery according to claim 1, wherein in the longitudinal direction of the fused portion, a length at a distal end of the shape is larger than a length of the fused portion at the folding line.
